(19) United States
(12) Patent Application Publication
(10) Pub. No.: US 2024/0403710 A1
(43) Pub. Date: Dec. 5, 2024

(54) SYSTEMS AND METHODS FOR INTERPRETING LANGUAGE USING AI MODELS

(71) Applicant: University of South Florida, Tampa, FL (US)

(72) Inventors: John Licato, Tampa, FL (US); Zaid Khalil Marji, Tampa, FL (US)

(21) Appl. No.: 18/655,593

(22) Filed: May 6, 2024

Related U.S. Application Data
(60) Provisional application No. 63/470,303, filed on Jun. 1, 2023.

(51) Int. Cl. G06N 20/00

(52) U.S. Cl. CPC G06N 20/00

(57) ABSTRACT

Systems and methods for artificial intelligence (AI)-based systems are described herein. In an aspect, the present disclosure relates to a computer implemented method that includes prompting a first trained large language model (LLM) to generate a plurality of arguments; determine a ranking of the plurality of arguments using a second trained LLM; and training a third LLM based on the ranking of the plurality of arguments and the plurality of arguments.

### CROSS-REFERENCE TO RELATED APPLICATIONS

This application claims the benefit of U.S. provisional patent application No. 63/470,303, filed on Jun. 1, 2023, and titled “SYSTEMS AND METHODS FOR INTERPRETING LANGUAGE USING AI MODELS,” the disclosure of which is expressly incorporated herein by reference in its entirety.

### BACKGROUND

Natural language processing (NLP) includes techniques that allow computers to understand language using various linguistic techniques. NLP can include both rules-based modeling of human language, as well as statistics, machine learning, deep learning, and other forms of Al.

Large language models (LLMs) are types of machine learning systems that can be trained using large datasets to generate text based on training data. LLMs can be used for generating responses to queries and analyzing data/images.

Improvements to LLMs and NLP can improve systems and methods processing and generating language.

### SUMMARY

In some aspects, the techniques described herein relate to a computer-implemented method including: prompting a first trained large language model (LLM) to generate a plurality of arguments; determining a ranking of the plurality of arguments using a second trained LLM; and training a third LLM based on the ranking of the plurality of arguments and the plurality of arguments.

In some aspects, the techniques described herein relate to a computer-implemented method, wherein the first trained LLM is the same as the second trained LLM.

In some aspects, the techniques described herein relate to a computer-implemented method, wherein the third LLM is the same as the second trained LLM.

In some aspects, the techniques described herein relate to a computer-implemented method, wherein determining the ranking of the plurality of arguments using the second trained LLM includes using the second trained LLM to judge a best argument of at least two of the plurality of arguments.

In some aspects, the techniques described herein relate to a computer-implemented method, wherein prompting a first trained LLM to generate a plurality of arguments further includes inputting a prompt including an ambiguous phrase to the first trained LLM.

In some aspects, the techniques described herein relate to a computer-implemented method, further including prompting the first trained LLM to determine an ambiguity in the ambiguous phrase of the prompt.

In some aspects, the techniques described herein relate to a computer-implemented method, wherein the ambiguous phrase comprises an open-textured term.

In some aspects, the techniques described herein relate to a computer-implemented method, wherein prompting the first trained large language model includes inputting a prompt according to a prompting language.

In some aspects, the techniques described herein relate to a computer-implemented method including: prompting a first trained large language model (LLM) using a predefined prompting language to produce a plurality of responses; filtering the plurality of responses to create a plurality of filtered responses; and training a second LLM based on filtered responses.

In some aspects, the techniques described herein relate to a computer-implemented method, wherein filtering the plurality of responses includes inputting the plurality of responses into a third trained LLM and prompting the third trained LLM to rank the plurality of responses.

In some aspects, the techniques described herein relate to a computer-implemented method, wherein the first trained LLM is the same as the second LLM.

In some aspects, the techniques described herein relate to a computer-implemented method, wherein the third trained LLM is the same as the second LLM.

In some aspects, the techniques described herein relate to a computer-implemented method, wherein filtering the plurality of responses to create the plurality of filtered responses includes applying a machine learning classifier to the plurality of responses.

In some aspects, the techniques described herein relate to a system for training a generative artificial intelligence (AI), the system including: a computing device including at least one processor and at least one memory, the at least one memory having computer-executable instructions stored thereon that, when executed by the at least one processor, cause the at least one processor to: receive a prompt file; generate a pair of responses using a trained generative AI model and the prompt file; output a comparison of the pair of responses based on the prompt file; train the trained generative AI model using the comparison and the pair of responses; and store the trained generative AI model.

In some aspects, the techniques described herein relate to a system, wherein the pair of responses include a pair of arguments.

In some aspects, the techniques described herein relate to a system, wherein the trained generative AI model is a language model.

In some aspects, the techniques described herein relate to a system, wherein the trained generative AI model is a large language model.

In some aspects, the techniques described herein relate to a computer-implemented method for providing artificial intelligence (AI)-based responses including: receiving a first input file; inputting the first input file to an iteratively trained generative AI model; and outputting, using the iteratively trained generative AI model, a response.

In some aspects, the techniques described herein relate to a computer-implemented method, wherein the iteratively trained generative AI model includes a language model.

In some aspects, the techniques described herein relate to a computer-implemented method, wherein the iteratively trained generative AI model includes a large language model.

In some aspects, the techniques described herein relate to a computer-implemented method, further including displaying the response using a user interface.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a flow chart illustrating example operations for training a large language model based on filtered response, according to an example implementation described herein.

FIG. 2A is a flow chart illustrating example operations training a large language model based on ranked arguments, according to an example implementation described herein

FIG. 2B is a flow chart illustrating example operations for outputting responses using iteratively trained generative AI models, according to an example implementation described herein.

FIG. 3 illustrates an example system and framework for training a model, according to an example implementation described herein.

FIG. 4 illustrates an example iteration of the framework illustrated in FIG. 3, including example data, according to an example implementation described herein.

FIG. 5 illustrates a prompting template that can be used in a multi-step prompting pipeline, according to example implementations described herein.

FIG. 6 illustrates a workflow for prompting with templates, according to example implementations described herein.

FIG. 7 illustrates an example user interface for interacting with a trained model, according to example implementations described herein.

FIG. 8 illustrates an example algorithm for training a generative language model, according to an example implementation described herein.

FIG. 9 illustrates example data from an experiment performed on an example implementation of the present disclosure.

FIG. 10, illustrates an example ranking of arguments from example scenarios and stances when compared to generations, according to an example implementation of the present disclosure.

FIG. 11 illustrates an example computing device.

FIG. 12 illustrates an example framework for analyzing interpretive arguments, according to an example implementation of the present disclosure.

FIG. 13 illustrates an example interface for implementing the framework illustrated in FIG. 12.

FIG. 14 illustrates an example scenario and argument for the framework illustrated in FIG. 12.

FIG. 15 illustrates example results including ratings of arguments generated according to the frameworks of implementations of the present disclosure.

FIG. 16 illustrates a table of example results including ratings of arguments for different models and prompts using the frameworks for analyzing interpretive arguments according to implementations of the present disclosure.

FIG. 17 illustrates a table of example results including ratings of arguments for different models and prompts using the frameworks for analyzing interpretive arguments according to implementations of the present disclosure.

FIG. 18 illustrates a table of example results including the average median order of each source of arguments from a study of frameworks for analyzing interpretive arguments according to implementations of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for resolving ambiguities in text, it will become evident to those skilled in the art that the implementations are not limited thereto, but are applicable for generative artificial intelligence systems and methods.

As used herein, the terms “about” or “approximately” when referring to a measurable value such as an amount, a percentage, and the like, is meant to encompass variations of ±20%, ±10%, ±5%, or ±1% from the measurable value.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

Deep learning models, including LLMs, may include artificial neural networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation.

The systems and methods described herein include improvements to LLMs and NLP that can be used for improving systems and methods for both processing and generating language. As a non-limiting example, implementations of the present disclosure include systems and methods for training machine learning models to automatically identify and/or resolve ambiguities in text. Identifying and/or resolving ambiguities in text improves systems and devices that rely on natural language instructions (e.g., a user providing instructions to control the system using natural language). Identifying ambiguities allows the system to seek clarification and/or delay executing instructions until the ambiguity is resolved. Resolving ambiguities includes allowing the system to determine a correct resolution to an ambiguity automatically, increasing the speed and/or accuracy of the system including the AI.

Existing systems and methods for training machine learning models include training the machine learning models using large quantities of human generated data (e.g., text written by humans). Using exclusively human-generated data can require significant amounts of labor to generate or collect the human-generated data. This increases the expense of training (or fine-tuning) machine learning models, and can prevent the use of machine learning models for certain tasks where insufficient training data can be obtained.

Implementations of the present disclosure can overcome the limitations of using exclusively human generated data for training or fine tuning LLMs. Example implementations include systems and methods that can be used to train or fine tune LLMs to identify and/or resolve ambiguities in language. Systems and methods described herein can include using one or more LLMs to generate training data, and then training either the same LLM (or a different LLM) based on the dataset generated by the one or more LLMs. The LLMs used in various implementations of the present disclosure can be selected to optimize the performance of the system. Alternatively or additionally, the LLMs can be any machine learning model. This allows, for example, for a lightweight LLM or other ML model to be trained or fine-tuned using a synthetic dataset generated by a larger and less efficient LLM. Alternatively or additionally, implementations of the present disclosure allow for humans to control or modify the fine-tuning of LLMs by optionally using human control over parts of the synthetic data generation process.

As yet another example, implementations of the present disclosure can be used to improve automated systems and methods for providing information to users. An example automated system can be a system for providing responses to queries (e.g., providing text/voice responses for customer service or public information). The automated system can optionally include one or more machine learning systems (e.g., LLMS and/or classifiers) that can be used to interpret and respond to natural language instructions and queries. Because user queries and/or instructions can be ambiguous (e.g., open textured), the way that the system responds to ambiguous queries can be important to providing consistent and/or correct responses. Implementation of the present disclosure can be used to test the responses of an automated service system to ambiguous queries, and/or determine how a rule applies to a specific query/instruction provided by a user. For example, a rule applied to an automated system for responding to customer queries may be to “provide helpful and informative responses to a user, without providing internal corporate information or unethical responses.”

The example rule includes ambiguities, because being helpful and informative may be in tension with providing internal corporate information, and the terms “internal corporate information,” “helpful” and “informative” may not have precise definitions that can be reduced to logical expressions.

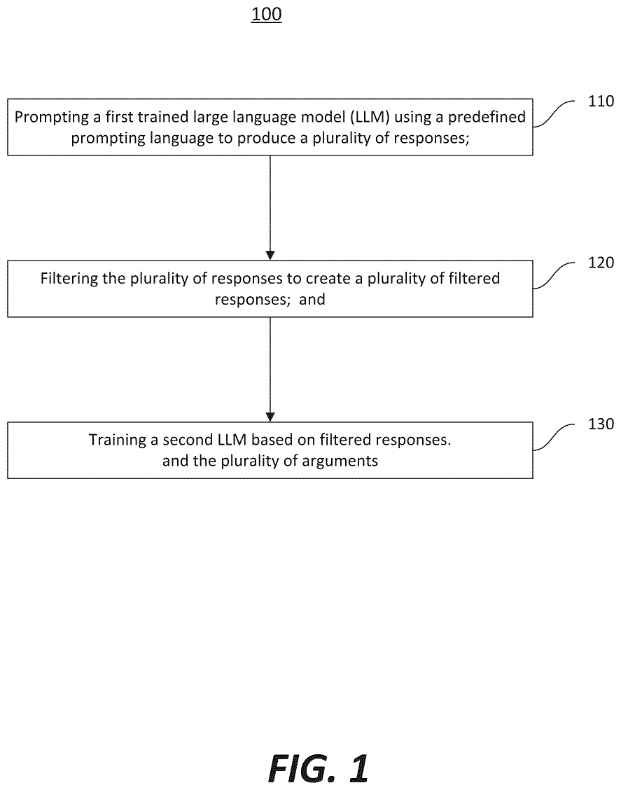

As described herein with reference to FIGS. 1-3, implementations of the present disclosure include training/fine-tuning machine learning models (including LLMs) to improve the responses of those machine learning models to ambiguous text, for example by generating arguments based on ambiguous rules or instructions, filtering the arguments, and using the filtered responses and arguments to fine tune or train an LLM.

With reference to FIG. 1, a computer-implemented method 100 is shown according to an example implementation of the present disclosure.

At step 110, the computer-implemented method can include prompting a first trained large language model (LLM) using a predefined prompting language to produce a plurality of responses.

At step 120, the computer-implemented method can include filtering the plurality of responses to create a plurality of filtered responses. Optionally, filtering the plurality of responses can be performed using AI or deep learning. Optionally, filtering can be performed using a machine learning classifier. Filtering the plurality of responses as described herein can be used to implement iterative improvements to machine learning model (e.g., the second LLM at step 130). For example, the filtering described at step 120 can include selecting the best arguments (e.g., “winning” arguments) from the plurality of responses. Optionally, filtering can include comparing the plurality of filtered responses to each other, and counting the number of times that a response is considered the best argument. Alternatively or additionally, filtering can include ranking or sorting the responses.

Alternatively or additionally, filtering can include prompting a trained machine learning model (e.g., an LLM) and/or a human reviewer to compare and/or rank the responses from the plurality of responses. In embodiments where a human reviewer is used to rank responses from the plurality of responses, it should be understood that the human reviewer can review the responses in addition to a trained machine learning model, classifier, LLM or any other filtering method described herein.

At step 130, the computer-implemented method can include training a second LLM based on filtered responses.

In some implementations, filtering can be performed using an LLM. For example, the filtering of the plurality of responses can be performed by inputting the plurality of responses to a third trained LLM, and prompting the third trained LLM to rank the plurality of responses. The ranked responses can then optionally be filtered, for example by rejecting a certain percentage of the responses (e.g., the lowest ranked 80%), or rejecting all responses below a certain threshold.

It should be understood that the first LLM, second LLM, and third LLM described with reference to FIG. 1 can be the same LLM, or three different LLMs, or that any two of the three LLMs can be the same.

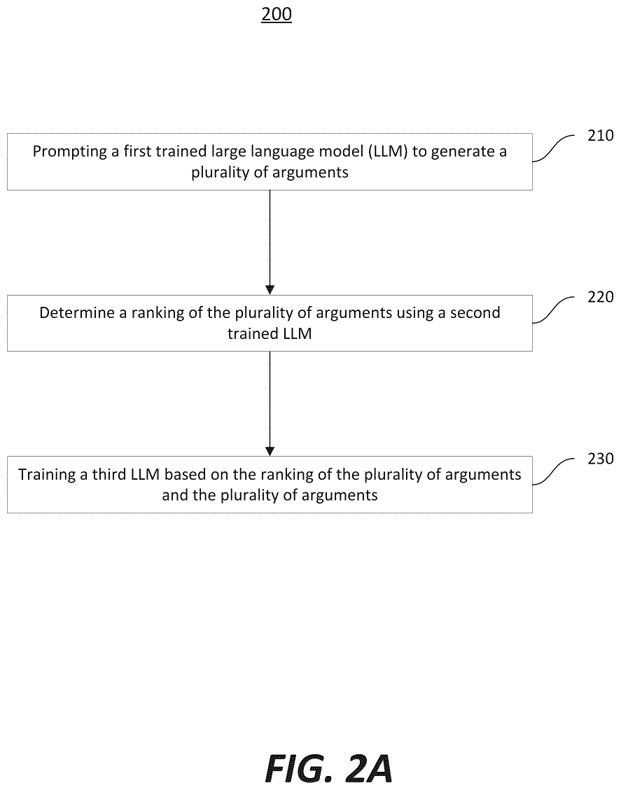

With reference to FIG. 2A, implementations of the present disclosure include a computer implemented method 200 for training an LLM based on natural language arguments.

At step 210, the method can include prompting a first trained large language model (LLM) to generate a plurality of arguments. Optionally, prompting the first trained LLM can include inputting a prompt to the first trained LLM comprising an ambiguous phrase. It should also be understood that prompting the first trained LLM can be performed using a prompting language (e.g., the prompting language described herein). Optionally, the first trained LLM can also be prompted to determine an ambiguity in the of the prompt.

At step 220, the method can include determining a ranking of the plurality of arguments using a second trained LLM. Optionally, determining the ranking of the arguments can include using the second trained LLM to judge a best argument of at least two of the plurality of arguments.

At step 230, the method can include training a third LLM based on the ranking of the plurality of arguments and the plurality of arguments.

As described with reference to FIG. 1, it should be understood that the first LLM, second LLM, and third LLM described with reference to FIGS. 2A and 2B can be the same LLM, or three different LLMs, or that any two of the three LLMs can be the same.

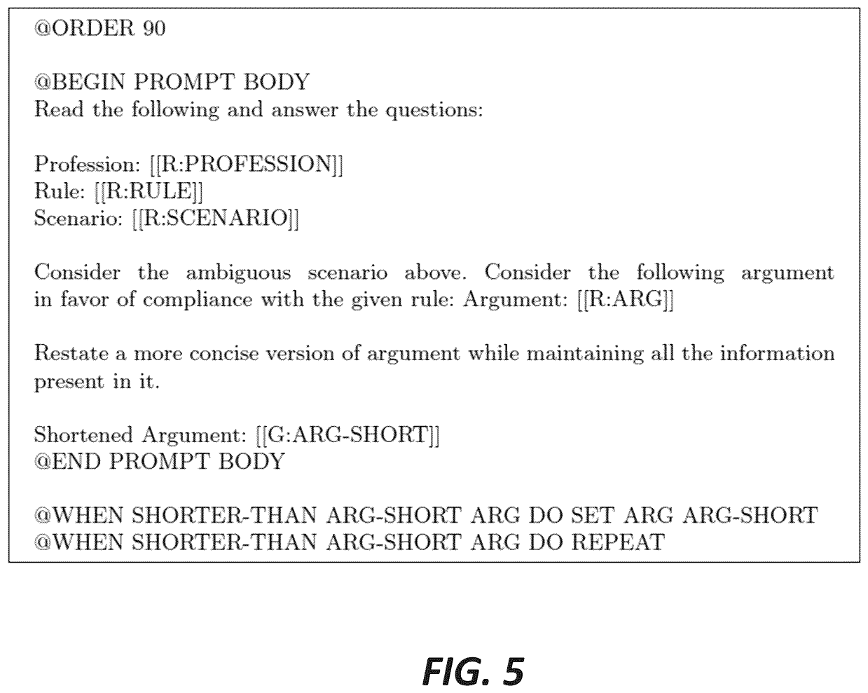

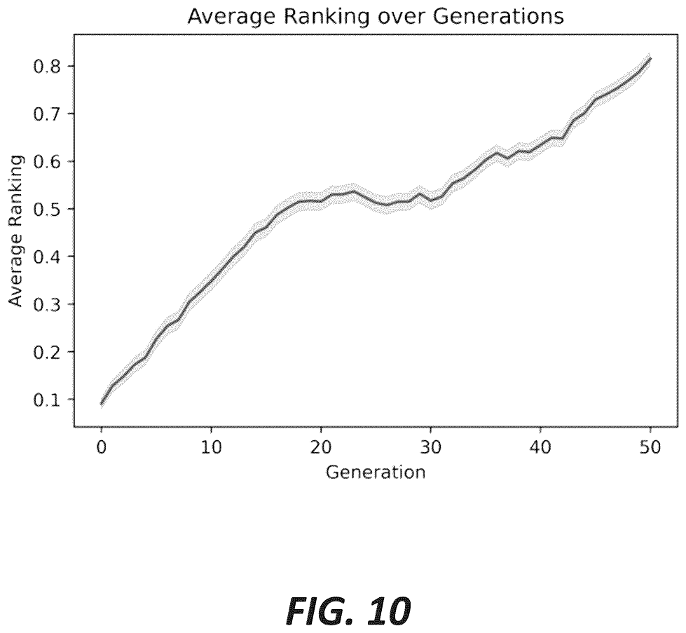

With reference to FIG. 6, the present disclosure includes systems for training generative AI. The system 600 can include a computing device 602. The computing device 602 can include any or all of the components of the computing device 1100 illustrated in FIG. 11. The computing device 602 can be configured to receive a prompt file 604 and a generative AI model 606. The prompt file 604 can be input into the generative AI model 606 to output responses 608. The responses 608 can include a pair of responses and a comparison of the pair of arguments. The responses 608 can be input into a matcher 610 and used to train the generative AI model 606 and/or as inputs to the prompt generator 612. The prompt file 604 and generative AI model 606 can be stored in a database 614. It should be understood that the system 600 illustrated in FIG. 6 can train the generative AI model 606 any number of times using any number of prompts from the prompt file 604.

Additionally, it should be understood that the system 600 can be used to implement the methods shown in FIGS. 1 and 2A. For example, the responses 608 can include a pair of arguments. Optionally, the generative AI model 606 can be a language model and/or a large language model.

Systems and methods described herein can also be used to output responses to user queries. With reference to FIG. 2B, a computer implemented method 250 disclosed herein can be used to provide artificial intelligence (AI)-based responses.

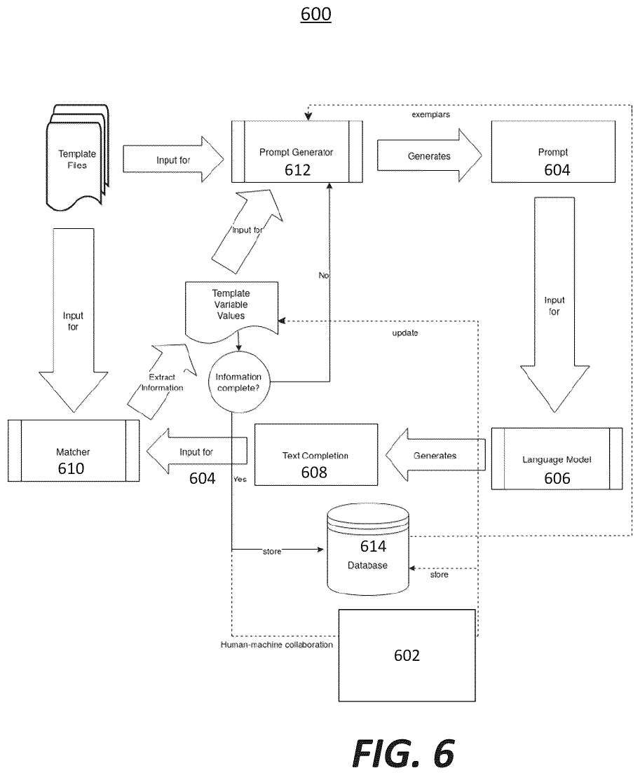

At step 260, the computer-implemented method 250 can include receiving a first input file. Optionally, the first input file can be a test input from a user (e.g., a web form). An example user interface 700 that can be used by implementations of the present disclosure is shown in FIG. 7.

At step 270, the computer implemented method 250 can include inputting the first input file to an iteratively trained generative AI model. The iteratively trained generative AI model can include models trained using any of the systems and methods described herein. As non-limiting examples, the iteratively trained generative AI model can include a language model and/or a large language model.

At step 280, the computer implemented method 250 can include outputting, using the trained generative AI model, a response. Optionally, a user interface, such as the user interface 700 shown in FIG. 7, can be used to output the response.

It should be appreciated that the logical operations described herein with respect to the various figures may be implemented (1) as a sequence of computer implemented acts or program modules (i.e., software) running on a computing device (e.g., the computing device described in FIG. 11), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 11, an example computing device 1100 upon which the methods described herein may be implemented is illustrated. It should be understood that the example computing device 1100 is only one example of a suitable computing environment upon which the methods described herein may be implemented. Optionally, the computing device 1100 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1100 typically includes at least one processing unit 1106 and system memory 1104. Depending on the exact configuration and type of computing device, system memory 1104 may be volatile (such as random access memory (RAM)), non-volatile (such as read-only memory (ROM), flash memory, etc.), or some combination of the two. This most basic configuration is illustrated in FIG. 11 by dashed line 1102. The processing unit 1106 may be a standard programmable processor that performs arithmetic and logic operations necessary for operation of the computing device 1100. The computing device 1100 may also include a bus or other communication mechanism for communicating information among various components of the computing device 1100.

Computing device 1100 may have additional features/functionality. For example, computing device 1100 may include additional storage such as removable storage 1108 and non-removable storage 1110 including, but not limited to, magnetic or optical disks or tapes. Computing device 1100 may also contain network connection(s) 1116 that allow the device to communicate with other devices. Computing device 1100 may also have input device(s) 1114 such as a keyboard, mouse, touch screen, etc. Output device(s) 1112 such as a display, speakers, printer, etc. may also be included. The additional devices may be connected to the bus in order to facilitate communication of data among the components of the computing device 1100. All these devices are well known in the art and need not be discussed at length here.

The processing unit 1106 may be configured to execute program code encoded in tangible, computer-readable media. Tangible, computer-readable media refers to any media that is capable of providing data that causes the computing device 1100 (i.e., a machine) to operate in a particular fashion. Various computer-readable media may be utilized to provide instructions to the processing unit 1106 for execution. Example tangible, computer-readable media may include, but is not limited to, volatile media, non-volatile media, removable media and non-removable media implemented in any method or technology for storage of information such as computer readable instructions, data structures, program modules or other data. System memory 1104, removable storage 1108, and non-removable storage 1110 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1106 may execute program code stored in the system memory 1104. For example, the bus may carry data to the system memory 1104, from which the processing unit 1106 receives and executes instructions. The data received by the system memory 1104 may optionally be stored on the removable storage 1108 or the non-removable storage 1110 before or after execution by the processing unit 1106.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure.

### Example 1

An example implementation of the present disclosure was studied.

When a governing law, mission order, code of ethical conduct, or other verbal or written instruction is produced and given to a subordinate, there is some expectation that the rule will be followed in the spirit in which it was created. But such rules may contain words or phrases that are open-textured; i.e. contain ambiguity that require interpretation to determine whether it is applicable to a certain situation. How can it be ensured that AI or human agents interpret open-textured phrases correctly? The present disclosure includes systems and methods designed to automate text interpretation and automate the resolution of ambiguities. (e.g., in open-ended rules). Embodiments of the present disclosure include a framework with related tools, methods, programming languages, and computer programs, and user interfaces that enable the use of large language models (LLMs) to perform advanced language-related tasks. The systems and methods described herein were primarily designed to enable the automation of interpretation of text through the use of interpretive arguments. Nonetheless, some of the tools described herein are general-purpose tools that enable elaborate interactions with large language models and can be useful in other natural language processing tasks.

The example implementation of the present disclosure includes systems and methods in the field of natural language processing (NLP), natural language understanding (NLU) and the interpretation of open-textured phrases in text. Any time a governing law, mission order, code of ethical conduct, or other verbal or written instruction is produced and given to a subordinate (in a fixed, referable form that can be referred to herein a rule), there is some expectation that it will be followed in the spirit in which it was created. Often this means there is an assumption that the intent of the rule is properly conveyed. But full conveyance of a rule's intent requires a multitude of background knowledge: the history behind the rule, prototypical examples of its proper and improper interpretations, the intended goals of the rule's creator, the proper scope of the rule's open-textured predicates, and so on [3, 2, 10, 12, 6, 5]. When determining how best to represent and convey rule intent, there are trade-offs with all known representational systems, from highly formal logical languages to informal natural languages. And the limitations of these systems becomes even more apparent when rule intent must be conveyed to individuals with very different reasoning styles, capabilities, and values: mixed human-AI teams, for example. A primary reason why intent is so difficult to communicate in text is the existence of open-textured terms (OTTs)—terms whose extensions are not completely and unambiguously fixed at the time of their initial use [3]. For example, consider a traffic regulation stating that vehicles must “keep to the right as far as is reasonably safe” [10]. Such a regulation would require interpretation by autonomous driving vehicles. But

it is implausible to exhaustively list an exception-free accounting of all possible scenarios and conditions that can be considered instances of the open-textured term “reasonably safe”—any such attempt would inevitably limit the scope of the regulation and render it fatally inflexible in the face of unanticipated conditions. In fact, use of OTTs can be a normal and/or unavoidable feature of regulatory and legal language [3, 2, 10, 12, 6, 5, 18], and thus there is a need for ways to address them in AI systems.

In practice, resolving disagreements on how to interpret rules that contain open-textured phrases can be done through the generation and exchange of interpretive arguments [14, 13, 6] which are used to support or attack an interpretation of a fixed expression within a fixed document. Formally, interpretive arguments are of the form: “If expression E occurs in document D, E has a setting of S, and E would fit this setting of S by having interpretation I, then E ought to be interpreted as I” [14]. For example, one might argue that a term t should be interpreted a certain way because the typical person would understand t as having a certain definition (argument from ordinary meaning), or even that previous interpretations of t are binding (argument from precedent). A closely related task, automated compliance detection, is the task of determining whether some behaviors can be interpreted as compliant with a set of rules. Determining such compliance requires interpretive argumentation; particularly when the rules contain open-textured terms [3]. Current artificially intelligent algorithms may be unable to perform either interpretive reasoning and/or automated compliance detection to a substantial degree. These limitations may be partially explained by the lack of resources (e.g., large-scale datasets and test environments) available to develop such agents.

An example machine learning paradigm is ‘pre-train, prompt, predict’ [7]. This paradigm addresses the challenge of the scarcity of large datasets that are required in the supervised-learning paradigm. Prompt-based learning can be used for zero-shot learning, one-

shot learning, as well as, few-shot learning [1, 15]. Zero-shot learning [16] means that a problem is solved without any training examples. In the NLP domain, this is possible due to the common-sense knowledge that is embedded in large language models that are trained on large corpora of text. For example, to solve a sentiment analysis problem in a zero-shot setting, a user can prompt a large language model (such as OpenAI's GPT-3 [1]) with the text: “I have been stuck in traffic for over an hour. I feel so”. It can be presumed that that the model will generate an appropriate sentiment as a completion for that prompt or, alternatively, the completion will be restricted to a set of predetermined outputs. One-shot and few-shot learning paradigms use similar prompts that include one or more solved examples to condition the model on the task at hand [19]. Explanation-based prompting, which started with chain-of-thought prompting [20] and many styles of prompting inspired by it, including self-ask [11] and maieutic prompting [4] can also be used. For example, a chain-of-thought prompt may be a question-answering task, where the task is presented in a few-shot learning fashion such that the provided examples don't simply answer the question, rather provide reasonable step-by-step inferences leading the to the correct conclusion. Such a style of prompts will encourage the generative language model to provide explanations before committing to an answer to the question, which can be experimentally found to improve accuracy.

The example implementation of the present disclosure studied includes several features:
1. A framework for automating reasoning about, and iteratively reducing, ambiguity in open-textured text.
2. A template design language for easily creating templates for language model prompts.
3. A template design language that can be used as a formal specification that encodes and formalizes knowledge and problem solving techniques.
4. A user interface for easily interacting with the framework, generating and editing templates created using our template design language, and iteratively reducing ambiguity in open-textured text.
5. A method to automatically generate training data and finetune a language model using that data.

The present disclosure includes a framework (referred to herein as “Aporia”) to automate reasoning about, and iteratively reduce, ambiguity in open-textured text. This framework is also designed to provide structure to the process of generating training data for interpretive argumentation through human gameplay, fully automatic text generation, or AI-assisted text generation. The generated training data can be used to improve existing language models through fine-tuning. The Aporia framework can be modeled as a game played by any group of three or more people or (AI agents). The game is played in rounds. At the end of each round points are awarded to the winner of that round. In each round, two players are randomly chosen to play against each other, with a third player designated as a judge. The example Aporia framework is as follows:
1. Each round starts with a tuple consisting of: —Profession—Rule that members of that profession are expected to follow—Ambiguous scenario describing an action taken by a member of that profession
2. Player 1 chooses which side to argue for (stance)
3. Player 1 provides an argument for their chosen stance
4. Player 2 provides a counter argument
5. Judge declares the winner;
6. Judge provides an explanation for their decision.

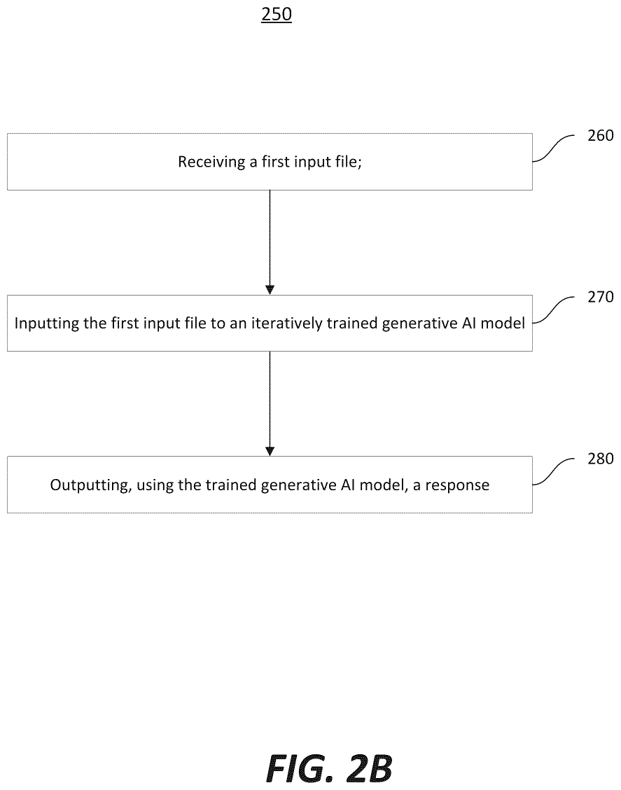

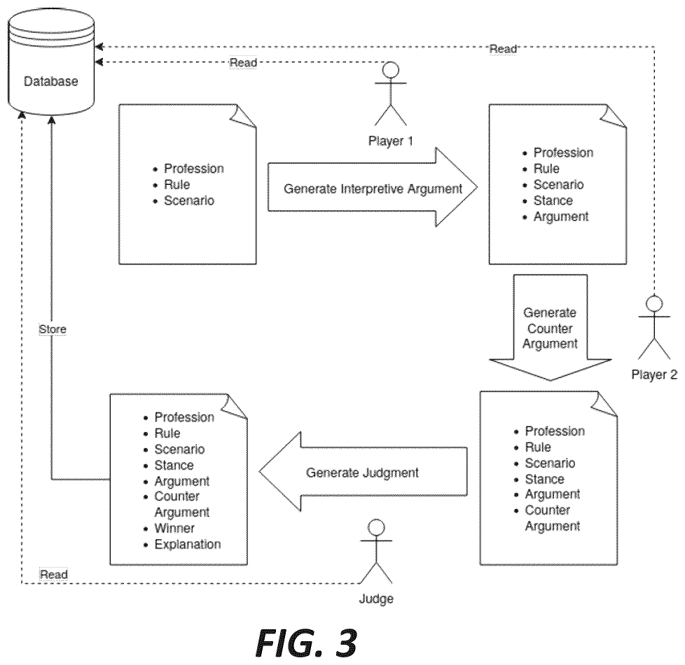

FIG. 3 shows an overview of the Aporia framework. The players (including the judge) take as inputs the information for the current round of the game, generate arguments, judgments, and explanations as necessary that complete one training example. The players may optionally have access to previous game rounds that allows them to review existing data that they may use to improve their current arguments. Those players may be human, AI, or AI-assisted humans. The process of iterating gameplay using the same rule and scenario allows arguments to be refined and improved to account for the weaknesses in arguments that are exposed by the counter arguments, as well as, which arguments tend to “win” in the framework. FIG. 4 shows a complete record of one round of the Aporia framework, which also serves as one structured training example.

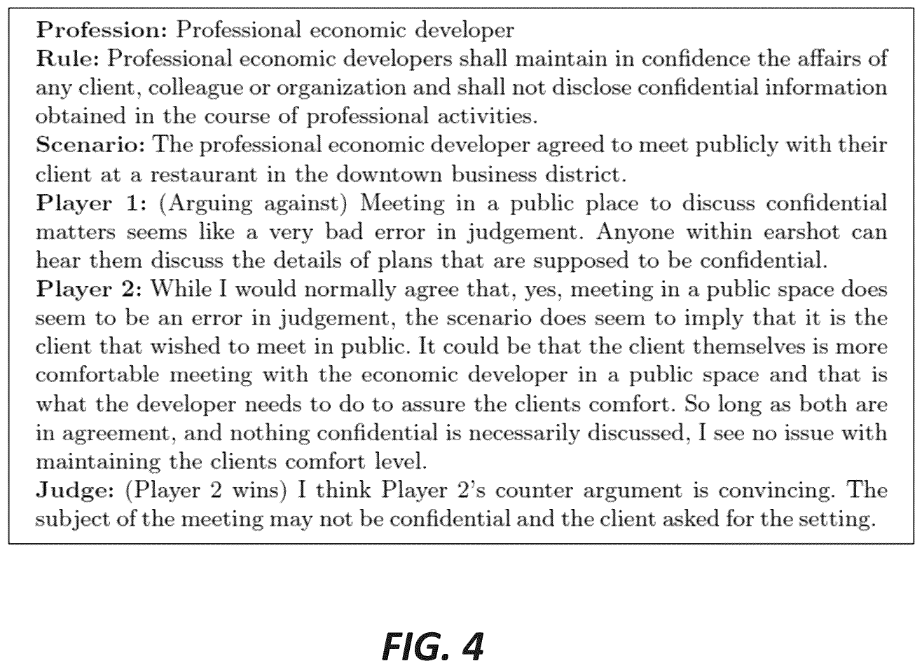

Implementations of the present disclosure also include a prompt template design language. The example implementation includes a prompt template design language that can be used to automate the generate complex prompts and interactions with a language model. This prompt design language can be a general-purpose language that is not restricted to the domain of interpretive argumentation. This language and the associated tooling was developed in the study to assist in the process of interacting with a language model and to provide the tooling necessary to automate complex interactions. One of the advantages of implementations of the template design language described herein is that it can provide a clear abstraction of the prompting logic that is completely disentangled from other concerns. This means that a template written in this language includes all the logic necessary to specify the behavior of the interaction between the system and the language model. This allows this language to function as a formal specification that encodes and formalizes knowledge and problem solving techniques. This can be in contrast to prompting solutions that use python (or other general-purpose languages) to automate the interactions. Such solutions can mix the logic of data retrieval, user interfaces, language model operations, with the prompting logic, which means that there is no clear separation of those concerns, leading to users, developers, researchers, and others to sift though large quantities of irrelevant code to get the answers they need about the prompting logic. This makes such solutions unsuitable as formal specifications or formalizations of the knowledge present in those prompts. This also allows this language and the associated tools to serve as educational tools for programmers and non-programmers alike to interact with language models with high levels of automation. FIG. 5 shows an example of one template in a multi-step pipeline of prompts. This example illustrates some of the features in that language. Here are some highlights that are illustrated through this example:
Variables can be used as text placeholders.
A placeholder can either be used to fill a value (called a ‘recall operation’) or to instruct the generation of the variable using a language model (called a ‘generate operation’).
[[R: PROFESSION]] can be used to indicate that the profession needs to be inserted here, where the profession has been previously fetched from a data source.
[[R: ARG]] can be used to indicate the an argument needs to inserted, which was generated in a previous step.
[[G: ARG-SHORT]] indicates that a shortened version of the argument needs to be generated using a language model, and the resulting argument is assigned to the variable ARG-SHORT.

The language also provides several flow control mechanisms such as conditionals and looping mechanisms.

@WHEN indicates a conditional.

SHORTER-THAN ARG-SHORT ARG is the condition that the length of the ARG-SHORT string variable is shorter than the length of the ARG string variable.

The first @WHEN statement, SET ARG ARG-SHORT indicates that when the conditional is met, the ARG variable's value needs to be updated to the ARG-SHORT variable value.

The second @WHEN statement indicates that if the condition is met, the current step needs to be run again to further shorten the argument, which provides one type of the looping interaction supported by this language.

The @ORDER statement defines the order of which templates are to be executed in multi-step pipelines.

This example illustrates some of the features of the language, however, it does not cover all of the features of the example implementation. The example implementation can also include:
Additional looping and conditional mechanisms
The use of data sources
Built-in support for few-shot learning Additional tooling is provided for:
Data management and organization
Fully automatic text completion
Human-machine collaboration mode for AI-assisted text completion

Additionally, it should be understood that the syntax and language features described with reference to FIG. 5 are only non-limiting examples. Implementations of the present disclosure can include different syntax words, phrases, and symbols, and can implement different combinations of language features.

FIG. 6 shows a high-level overview of how the prompting with templates workflow operates. The prompt template designer provides the template files. Those files are used to generate prompts which are used to prompt a language model to complete the text. A matching sub-system is then used to parse the output of the language model, extract the necessary information including variables that are assigned using the generated text. In some applications, the language model may not generate all the necessary information in the first run, therefore, the process can be iterated until the information is determined to be complete. At that point, data is logged and optionally presented to the user through a user interface.

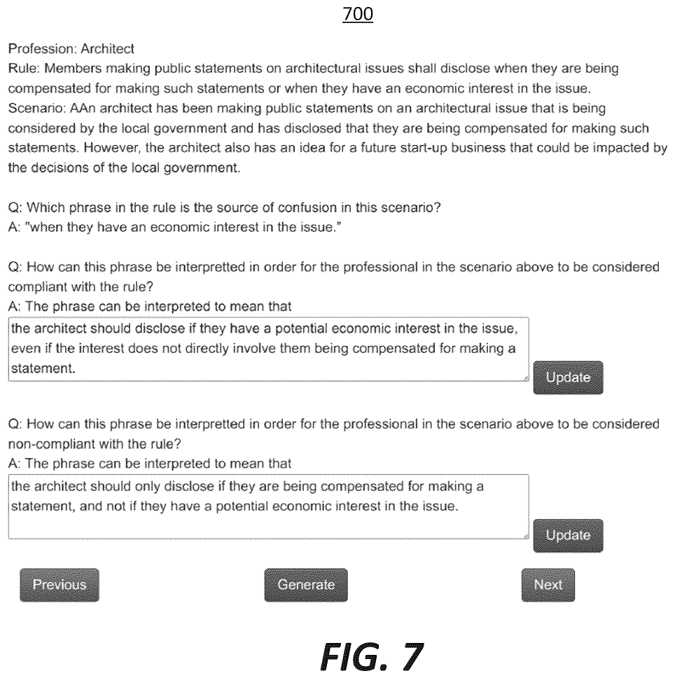

FIG. 7 shows a partial screenshot of a web-based user interface. The screenshot shows a completed prompt in human-machine collaboration mode. Variables that are recalled (eg. [[R: PROFESSION]]) are already inserted as a static part of the text, while variables that were generated using a language model are presented in editable textboxes with a corresponding ‘Update’ button that allows a human operator to review, edit, update, and regenerate text completions. The ‘Next’ and ‘Previous’ buttons allows a human operator to navigate through the steps in a multi-step pipeline or to step through multiple prompts generated using looping mechanisms such as the one in FIG. 5. Again, it should be understood that the user interface shown in FIG. 7 is only a non-limiting example. FIG. 8 illustrates another example method and algorithm for fine tuning a generative language model based on interpretive arguments, according to implementations of the present disclosure.

As used herein, the term “fine tuning” refers to further training a trained machine learning model using additional data. An example application of fine tuning is when a machine learning model is trained on a large dataset (e.g., a large language model). The large dataset can train the machine learning model to have a general capability, for example in natural language processing. Fine tuning can be performed using a specialized dataset targeted to a particular context or use case (e.g., particular types of language in the context of a machine learning model) to improve the performance of the trained machine learning model. A non-limiting example of fine tuning known in the art is “instruction tuning” where a LLM is trained to output responses to instructions based on pairs of instructions and corresponding outputs to those instructions.

The example implementation can further include any combination of the following features:

Generating and assigning variables as a first-class language construct.

Advanced and robust looping and iteration mechanics with conditionals.

Human-machine collaboration mode that allows users to interactively edit generated prompts.

The use of prompt templates as a form of guided problem-solving and the development of such templates in an expert-systems style.

The example implementation of the present disclosure includes iteratively improving interpretive arguments generation through fine-tuning. The present disclosure includes a method to continuously improve language models for the task of generating interpretive arguments. The example implementation can include both an iterative process of argument generation and filtration. The argument filtration process can be used to drive an iterative improvement. The filtration process can be automated using supervised learning classifiers or few-shot learning classifiers using the following example steps:

Generate a set of interpretive arguments of size N.

Compare pairs of arguments using classifiers that identify which argument is better.

Count the number of times an argument was considered better.

Use the subset of M best arguments (where M<N) for finetuning the model. This procedure may be improved by using a multi-step pipeline of different classifiers at multiple stages. It may also be improved by instead of comparing all possible pairs of arguments to use a subset of comparisons that approximate the output of this procedure while requiring a substantially few number of comparisons. Human annotators may also be used instead of or to supplement the argument filtration process.

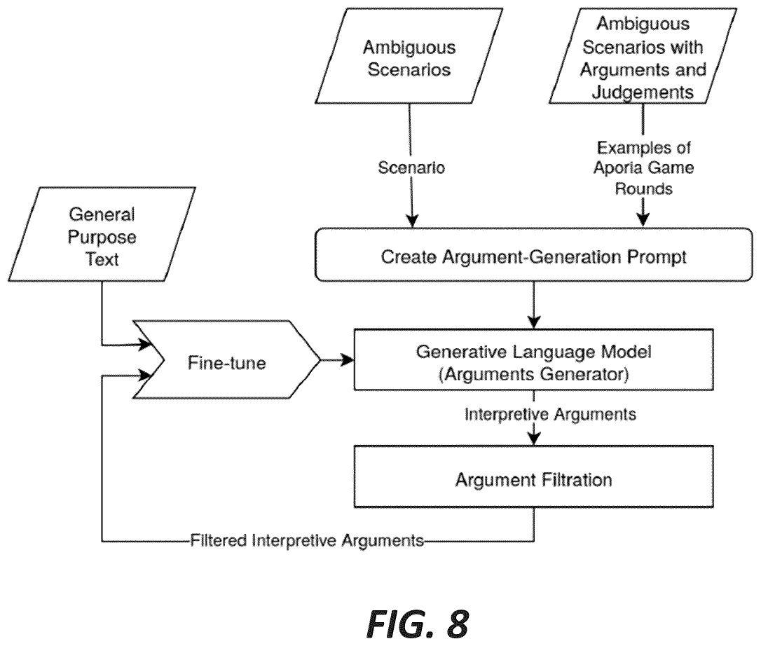

The study shows that using large language models such as OpenAI's GPT-3 can produce arguments that are more convincing than human annotators. A human study collected some human arguments from human annotators, and the study generated some example arguments using the prompt template design language and the associated tooling. The study used two different language models for generation purposes, namely text-davinci-003 and text-davinci-002, and the study asked users to rate each argument on a 5-points Likert scale that goes from ‘Very convincing’ (5) to ‘Very unconvincing’ (1). The study collected 5 different annotations per argument and reported the average of the median for all arguments. FIG. 9 shows the results. As can be observed, machine generated arguments were consistently rated as being more convincing.

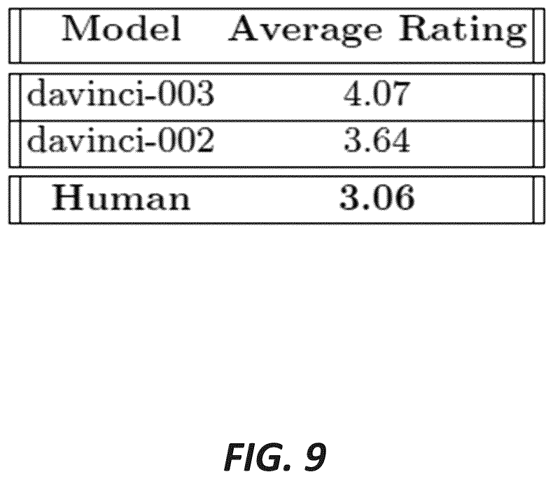

FIG. 10 shows the average ranking of the top 5 performing arguments in multiple generations of the iterative finetuning for improving argument generation discussed earlier. Results show that this method does lead to consistent generational improvements through repeated argument generation, argument filtration, and language model finetuning. This method has certain limitations in terms of the reward hacking problem that is commonly observed in the reinforcement learning field. Improvements in the quality of pre-trained large language models and the inclusion of human feedback will be necessary to deliver a viable working solution.

The example implementation of the present disclosure was configured to identify and resolve ambiguities in text, however, it should be understood that implementations of the present disclosure can be used for training any type of generative AI model. None limiting examples of applications that implementations of the present disclosure can be used for include the following non-limiting examples.

Law: The law is a domain where interpretation of open-textured text is a recurring theme. As non-limiting examples lawyers can use this system to analyze laws in order to find interpretations that are favorable to their clients. Legislators can use this system to improve the text of the proposed laws in order to avoid legal loopholes and other undesired or unexpected effects of ambiguity in the text of the proposed laws. Robo-lawyers can incorporate aspects of the present disclosure. Systems that users can use to get legal advice can incorporate aspects of the present disclosure.

Engineering Products: Any product commercial or otherwise that needs to comply with some set of rules can incorporate aspects of the present disclosure. Non-limiting examples include: Self-driving cars that can interpret the traffic laws of the jurisdiction they are driving in and reasonably understand the rules of the road. Likewise, aspects of the present disclosure can be used for drones that are provided mission statements and/or additional instructions in natural language.

Education: Students can use the provided tools to learn about different topics including: learning about debate, learning about ambiguity in language and/or learning how to prompt language models

### EXAMPLE 2

Implementations of the present disclosure include systems and methods for automating the process of evaluating open-textured phrases. The systems and methods disclosed herein include automated evaluation of open-textured phrases, training machine learning models and LLMs for evaluation of open textured phrases, and/or fine tuning machine learning and LLMs for evaluating open textured phrases.

“Open textured phrases” include phrases in language that can be dependent on context and/or human intentions.” Therefore there may not be a precise condition that can be used to determine whether a phrase is an open textured phrase.

As a non-limiting example, the phrase “avoid situations where you are impeding traffic” may be an open-textured phrase. This phrase may be a useful command both to humans and/or AI systems (e.g., self driving cars) because it generally communicates the goal of not impeding traffic. However, without other context or rules, “impeding traffic” is open textured because it is susceptible to the context and/or intentions of the user. For example, if a car is driving the speed limit, but other cars wish to drive faster than the speed limit, then the car is arguably “impeding traffic” and violates the rule, even though driving faster would violate other rules (e.g., the speed limit).

An AI system like the self-driving car of the example benefits from implementations of the present disclosure that improve the interpretation of open-textured phrases. For example, detecting that a phrase in an instruction is an open-textured phrase can allow the AI system to not implement the instruction (e.g., until clarification is provided), request clarification, request a new instruction, and/or analyze the open textured phrase to mitigate or resolve ambiguities in the open-textured phrase.

As yet another example, implementations of the present disclosure allow for natural language, including open-textured phrases, to be used as an alternative (or addition) to formal logic. Formal logic can be limited to situations where the inputs and outputs are precisely known ahead of time and can be structured into formal propositions. Many natural language sentences (e.g., rules, laws, instructions, etc.) cannot anticipate every possible situation ahead of time. Thus, natural language often includes open-textured phrases that are interpreted using both the words of the natural language, as well as the context, intention, and history. Non-limiting examples of interpretation include arguments from: ordinary meaning, technical meaning, contextual harmonization, precedent, analogy, legal concept, general principles, history, purpose, substantive reasons, and intention.

The example implementation described herein includes systems and methods that can improve automated interpretive reasoners. As used herein, an automated interpretive reasoner includes a system that can be capable of understanding generating and/or reasoning over interpretive arguments. Automated interpretive reasoners can be part of a larger AI system (e.g., a self-driving vehicle) where the automated interpretive reasoner can be optionally part of a larger control and/or natural language processing pipeline that converts a user's natural language instructions into control decisions.

In general, automated interpretive reasoners can allow AI agents to interpret instructions, rules, and/or any other textual inputs correctly. For example, automated interpretive reasoners can allow for AI agents to produce explanations for why an interpretation was chosen.

Existing sources of data about interpretive argument lack structure and labeling, which can limit their use for training machine learning systems to analyze or generate interpretive arguments. For example, a transcript of an argument in a court (e.g., the US Supreme court) can involve a complicated factual record, a variety of parties and issues, and a variety of legal and/or factual arguments. The transcript of such a court argument may not include labeling or structure that allows for interpretive arguments to be extracted and/or evaluated separately. Accordingly, even though transcripts of real arguments, like court arguments, can include interpretive arguments, those datasets may lack the structure to be directly useful as tools for training and/or fine tuning machine learning systems directed to interpretive arguments.

As described in example 1, implementations of the present disclosure

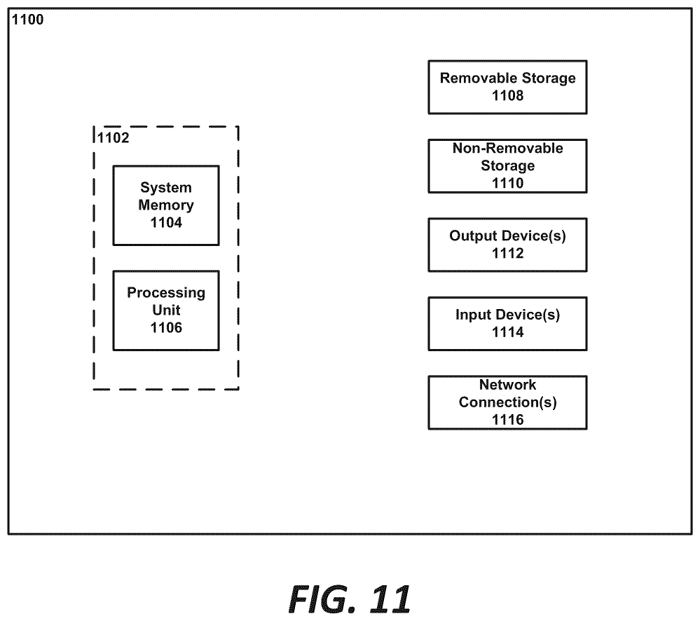

include frameworks for presenting and/or evaluating interpretive arguments. In the present example, a round can include phases of reading (e.g., receiving a written scenario), presenting a first argument, presenting a second argument, and a judging phase. As described with reference to FIG. 4, additional information (e.g., rules or roles) can be received as part of the reading phase. FIG. 12 illustrates an example flow of reading phase, first argument, second argument and judging. It should be understood that different implementations of the present disclosure can include different numbers of phases, for example that there can be any number of argument phases, and/or any number of judging phases. Additionally, it should be understood that any or all of the “Judge” and “Player 1” and “player 2” can optionally be implemented using one or more machine learning models to automate the process of generating and judging the interpretive arguments. It should also be understood that any number of “player” roles and judging roles can be used in different implementations of the present disclosure.

Optionally, the present disclosure can include performing prompt-based learning in addition to, or alternatively to, the fine tuning described herein. Prompt-based learning uses example input/output pairs as part of a prompt, without requiring that a trained machine learning model be further trained.

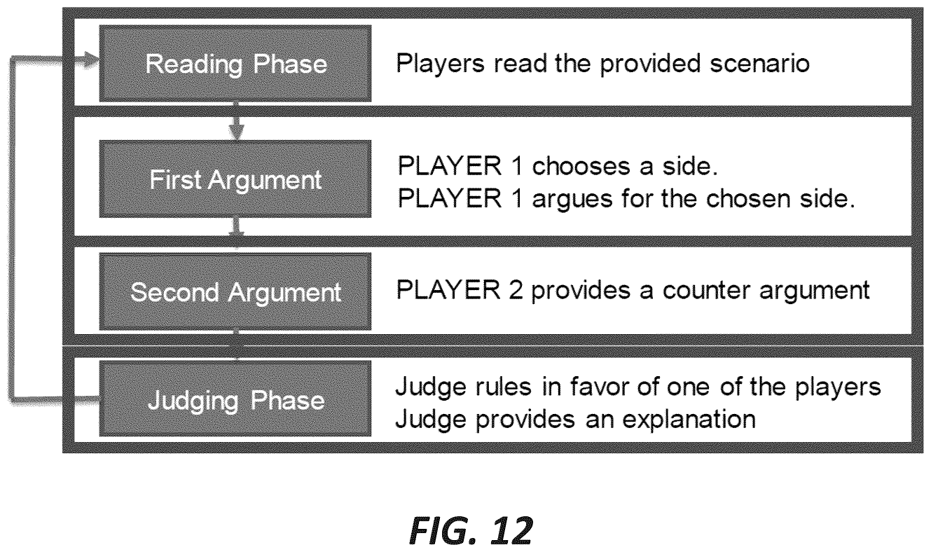

As shown in FIG. 13, implementations of the present disclosure can further include systems for automating prompting machine learning models to implement the frameworks for configuring and implementing machine learning models described herein. FIG. 13 illustrates an example user interface for automating a scenario similar to the one illustrated in FIG. 4. The user interface can allow a user to define a multi-step “prompting pipeline,” fetch data (e.g., text) from data sources, parse and extract text output in response to prompts (e.g., for use in other prompts), and/or automate the creation of few-shot learning prompts. The user interface shown in FIG. 13 can optionally be used to configure systems and methods that run without human intervention (i.e., are fully automated).

Optionally, the systems for automating machine learning prompts described herein can include systems for creating prompts using few-shot learning and/or introspective prompts.

### EXAMPLE 3

An additional study was performed using implementations of the present disclosure including generation and evaluation of machine arguments.

The study included 16 scenarios with 5 human arguments in favor of compliance and 5 human arguments in favor of non-compliance for each scenario. All of those arguments had 5 different annotations of their persuasiveness. The goal in the example was to generate 20 different arguments for each scenario using LLMs: 10 arguments in favor of compliance and 10 in favor of non-compliance.

The example implementation used GPT-3 models of different sizes, prompt designs, and both zero-shot and few-shot prompting. The study used two prompt designs. The first is a simple prompt that is copied directly from a question format. For the few-shot learning version of this prompt the study used 3-shot learning. The number of exemplars was chosen based on the smallest context size of the available models. The studied text-curie-001 model has a context size of 2000 tokens, while the studied text-davinci-003 model has a context size of 4000. Therefore, the output of the simple prompts needed to remain below 2000 tokens. Three exemplars was the maximum number that could be consistently included in the prompt without exceeding the maximum tokens limit. For each argument, the study first excluded all human arguments that match the profession of the argument in question. The remaining arguments were sorted from the highest quality to the lowest quality (based on evaluations), and the 6 best arguments were selected. From this set, the study randomly selected a subset of 3 arguments for use as exemplars and presented them as part of the prompt in a random order. The exemplars selected for each argument generation are part of the dataset.

The second example prompt design is a 10-steps introspective design that allows the LLM to iteratively formulate and improve its arguments. The introspective prompt pipeline can break down the task of interpretive argumentation into discrete tasks which in concert are designed to generate quality arguments. The individual questions and steps were inspired from multiple sources. These types of questions can be used to guide a LLM to produce high quality arguments. The LLM is repeatedly asked to elaborate on critical aspects of its response, attempt to find weaknesses or omissions in its arguments, and iteratively improve those arguments as it follows the steps in the introspective pipeline. The prompts used in this prompting style are significantly larger than the ones used in the simple prompting style. For this reason, the text-curie-001 context size of 2000 tokens was not a suitable choice for the introspective prompts especially for the few-shot learning setting. It should be understood that the example prompts and prompt lengths described herein are intended only as non-limiting examples, and that in some implementations of the present disclosure longer and/or shorter prompts can be used, and that LLMs with longer and/or shorter context windows can also optionally be used.

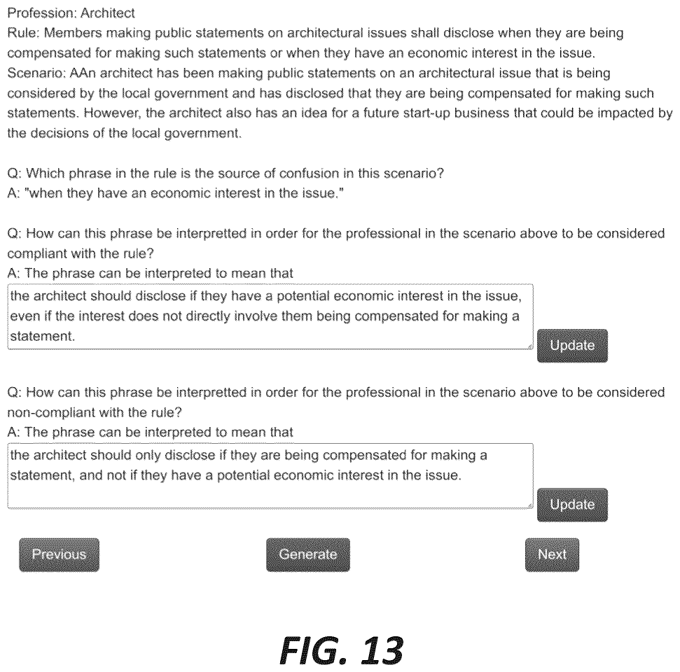

For the few-shot learning version of this prompt the study used 2-shot learning. Similar to the simple prompting style, the number of exemplars was made to ensure the prompt fits in the context size of 4000 which is the context size of the largest models. The study curated 4 exemplars that span all 10-steps of this prompt design. No profession occurs more than once in this set of exemplars. FIG. 14 shows an argument generated in favor of compliance using this prompt design. For each argument, the study excluded all exemplars that match the profession of the argument in question. From the set of the remaining exemplars, the study randomly selected a subset of 2 arguments for use and presented them as part of the prompt in a random order. The exemplars selected for each argument generation are part of the dataset.

Those two prompt designs were chosen to study whether an introspective prompt design could yield better arguments compared to the simpler prompt design. The study also used both zero-shot and few-shot prompts to answer the research question of whether few-shot learning could yield better arguments compared to a zero-shot learning design. Finally, the study used models of different sizes. For the simple prompts, the study used text-davinci-003 and text-curie-001; while for the introspective prompts, the study used text-davinci-003 and text-davinci-002. It should be understood that implementations of the present disclosure can include use of other machine learning models (e.g., variants of GPT-4).

At this point, the study had 16 scenarios with 5 human arguments in favor of compliance and 5 human arguments in favor of non-compliance, as well as 10 machine arguments in favor of compliance and 10 machine arguments in favor of non-compliance for a total of 320 machine-generated arguments. All of the human arguments had 5 different annotations of their persuasiveness. As described herein, the study evaluated the persuasiveness of the machine-generated arguments by collecting at least 5 different annotations for each of the machine-generated arguments.

Each question included 5 arguments. Each scenario-stance pair had to included twice with a different subset of five questions from the ten that were generated. The study split the arguments based on their source deterministically, and hence the questions required participants to order arguments for one of the two available subsets consistently.

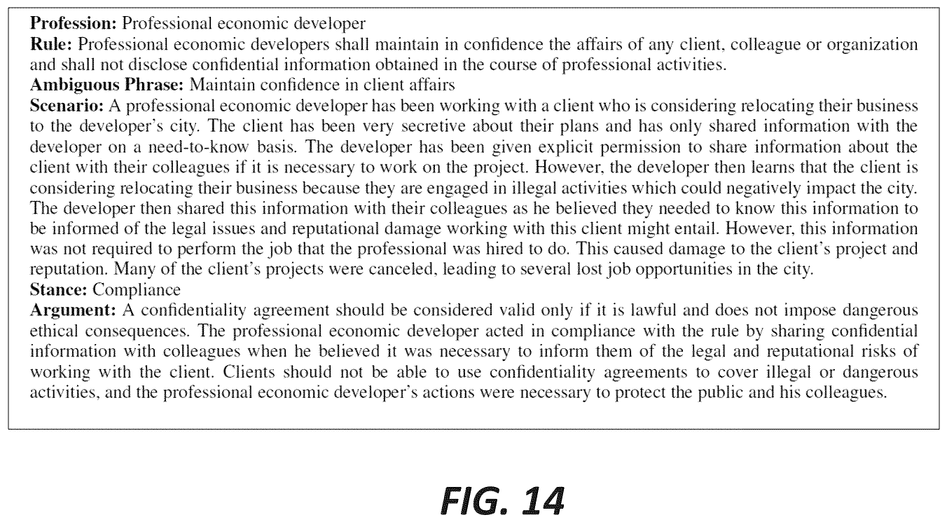

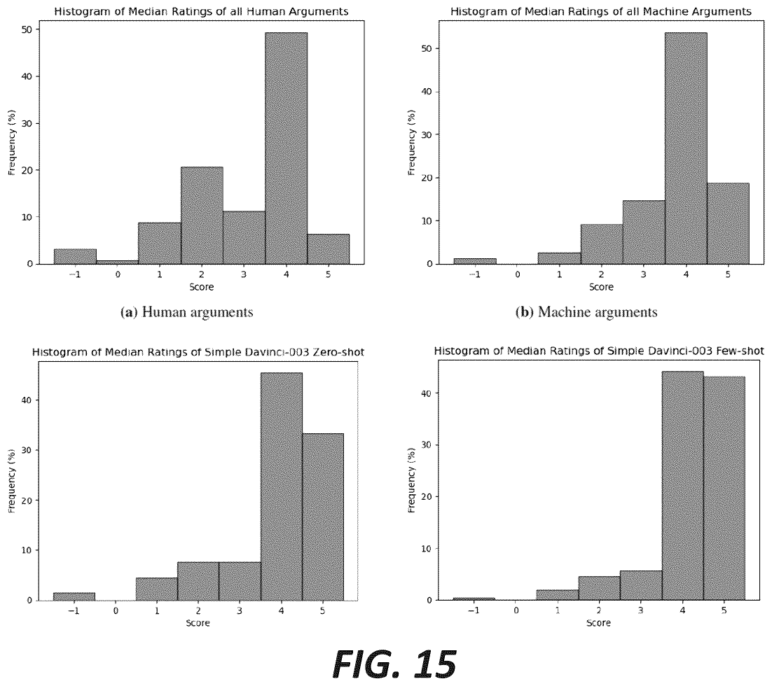

The average median rating for all machine-generated arguments was 3.63 with standard deviation of 1.06. The item-weighted average is 3.45. FIG. 15 shows the distribution of the median ratings for all machine arguments and all human arguments. These results indicate that the human annotators believe that machine generated arguments were consistently more persuasive than human written arguments. FIG. 16 shows a detailed breakdown of the experiments carried out in the study. In order to verify the statistical significance of those results the study conducted one-way ANOVA for all of the machine-generated argument and got F-statistic of 30.5 and p<0.01 which shows a significant difference between the group means.

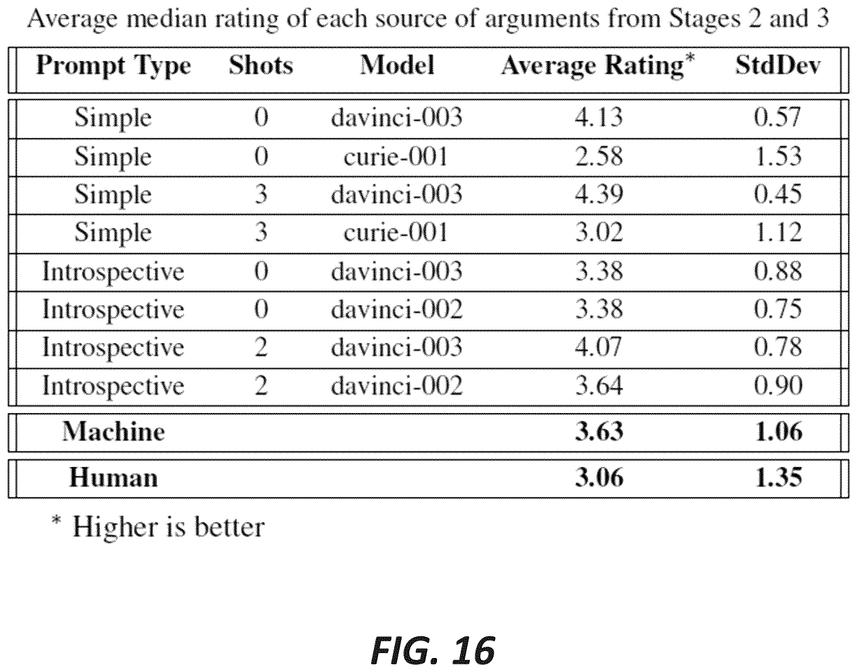

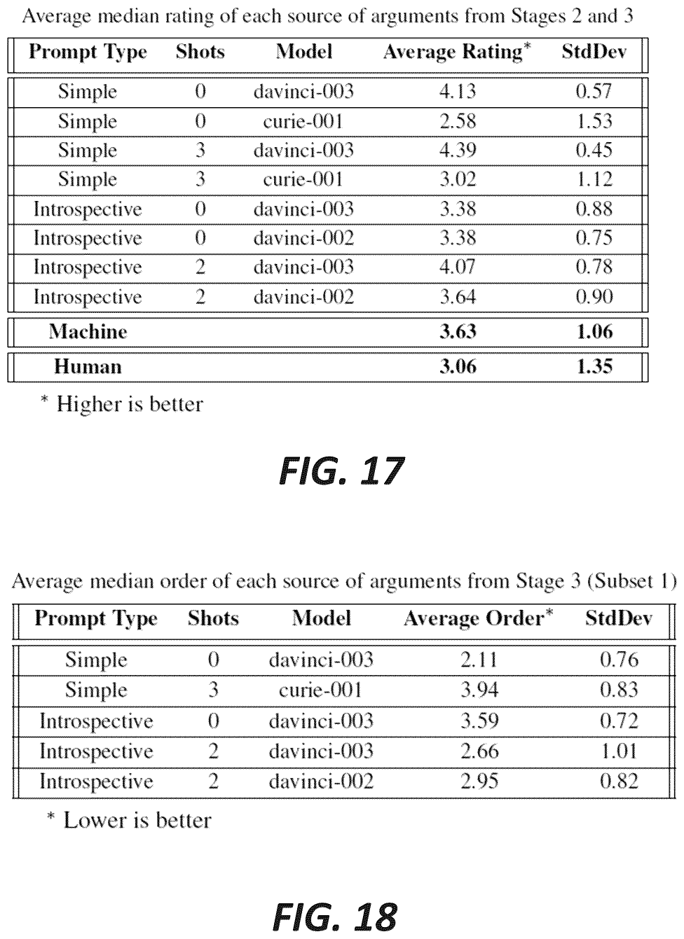

Examining the results shows that few-shot learning can outperform the zero-shot learning prompts. The results also show that the text-curie-001 model using 3-shot learning and simple prompts is roughly equivalent to the performance of the human arguments. The same model with zero-shot learning is the only model that under-performs compared to the human results. The results further show also notice that the introspective prompt design under-performs compared to the simpler prompting approach. Overall, the machine-generated arguments outperform the human arguments. FIG. 17 and FIG. 18 show the average median for all the machine-generated arguments for different portions of the studies described herein. Since the argument sources were split deterministically, FIGS. 17 and 18 tables show the results of each of the two subsets independently. The arguments that were labeled as most convincing (top) got a score of 1, while the ones labeled as least convincing (bottom) got a score of 5. The results show that the relative ordering of all sources of arguments is consistent with the average median rating in FIG. 16.

### REFERENCES

[1] Brown, T., Mann, B., Ryder, N., Subbiah, M., Kaplan, J.D., Dhariwal, P., Neelakantan, A., Shyam, P., Sastry, G., Askell, A., et al.: Language models are few-shot learners. Advances in neural information processing systems 33, 1877-1901 (2020).
[2] Franklin, J.: Discussion paper: How Much of Commonsense and Legal Reasoning is Formalizable? A Review of Conceptual Obstacles. Law, Probability and Risk 11(2-3), 225-245 (June-September 2012).
[3] Hart, H.: The Concept of Law. Clarendon Press (1961).
[4] Jung, J., Qin, L., Welleck, S., Brahman, F., Bhagavatula, C., Bras, R.L., Choi, Y.: Maieutic prompting: Logically consistent reasoning with recursive explanations. arXiv preprint arXiv: 2205.11822 (2022).
[5] Licato, J., Marji, Z.: Probing formal/informal misalignment with the loophole task. In: Proceedings of the 2018 International Conference on Robot Ethics and Standards (ICRES 2018) (2018).
[6] Licato, J., Marji, Z., Abraham, S.: Scenarios and recommendations for ethical interpretive ai. In: Proceedings of the AAAI 2019 Fall Symposium on Human-Centered AI. Arlington, VA (2019).
[7] Liu, P., Yuan, W., Fu, J., Jiang, Z., Hayashi, H., Neubig, G.: Pre-train, prompt, and predict: A systematic survey of prompting methods in natural language processing. arXiv preprint arXiv: 2107.13586 (2021).
[8] Microsoft: prompt-engine-py—a utility library for creating and maintaining prompts for large language models (2023), https://github.com/microsoft/prompt-engine-py.
[9] palletsprojects.com: Template design documentation—jinja documentation (2023), https://jinja.palletsprojects.com/en/3.1.x/templates/.
[10] Prakken, H.: On the problem of making autonomous vehicles conform to traffic law. Artificial Intelligence and Law 25(3), 341-363 (September 2017). https://doi.org/10.1007/s10506-017-9210-0, https://doi.org/10.1007/s10506-017-9210-0.
[11] Press, O., Zhang, M., Min, S., Schmidt, L., Smith, N.A., Lewis, M.: Measuring and narrowing the compositionality gap in language models. arXiv preprint arXiv:2210.03350 (2022).
[12] Quandt, R., Licato, J.: Problems of Autonomous Agents following Informal, Open-textured Rules. In: Lawless, W.F., Mittu, R., Sofge, D.A. (eds.) Human-Machine Shared Contexts. Academic Press (2020).
[13] Rotolo, A., Governatori, G., Sartor, G.: Deontic defeasible reasoning in legal interpretation: Two options for modelling interpretive arguments. In: Proceedings of the 15th International Conference on Artificial Intelligence and Law. pp. 99-108. ICAIL '15, ACM, New York, NY, USA (2015). https://doi.org/10.1145/2746090.2746100, http://doi.acm.org/10.1145/2746090.2746100
[14] Sartor, G., Walton, D., Macagno, F., Rotolo, A.: Argumentation schemes for statutory interpretation: A logical analysis. In: Legal Knowledge and Information Systems. (Proceedings of JURIX 14). pp. 21-28 (2014).
[15] Schick, T., Schu\ddot{ }tze, H.: Exploiting cloze questions for few shot text classification and natural language inference. arXiv preprint arXiv: 2001.07676 (2020)
[16] Sun, X., Gu, J., Sun, H.: Research progress of zero-shot learning. Applied Intelligence 51(6), 3600-3614 (2021).
[17] thunlp.github.io: Openprompt documentation (2023), https://thunlp.github.io/OpenPrompt/index.html.
[18] Vecht, J.J.: Open texture clarified. Inquiry 0(0), 1-21 (2020). https://doi.org/10.1080/0020174X.2020.1787222, https://doi.org/10.1080/0020174X.2020.1787222
[19] Wang, Y., Yao, Q., Kwok, J.T., Ni, L.M.: Generalizing from a few examples: A survey on few-shot learning. ACM computing surveys (csur) 53(3), 1-34 (2020)
[20] Wei, J., Wang, X., Schuurmans, D., Bosma, M., Chi, E., Le, Q., Zhou, D.: Chain of thought prompting elicits reasoning in large language models. arXiv preprint arXiv:2201.11903 (2022).
[21] bigscience workshop: Promptsource—toolkit for creating, sharing, and using natural language prompts (2023), ithub.com/bigscience-workshop/promptsource

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The following patents, applications, and publications, as listed below and throughout this document, describes various application and systems that could be used in combination the exemplary system and are hereby incorporated by reference in their entirety herein

What is claimed:

1. A computer-implemented method comprising:
prompting a first trained large language model (LLM) to generate a plurality of arguments;
determining a ranking of the plurality of arguments using a second trained LLM; and
training a third LLM based on the ranking of the plurality of arguments and the plurality of arguments.

2. The computer-implemented method of claim 1, wherein the first trained LLM is the same as the second trained LLM.

3. The computer-implemented method of claim 2, wherein the third LLM is the same as the second trained LLM.

4. The computer-implemented method of claim 1, wherein determining the ranking of the plurality of arguments using the second trained LLM comprises using the second trained LLM to judge a best argument of at least two of the plurality of arguments.

5. The computer-implemented method of claim 1, wherein prompting a first trained LLM to generate a plurality of arguments further comprises inputting a prompt comprising an ambiguous phrase to the first trained LLM.

6. The computer-implemented method of claim 5, further comprising prompting the first trained LLM to determine an ambiguity in the ambiguous phrase of the prompt.

7. The computer-implemented method of claim 6, wherein the ambiguous phrase comprises an open-textured term.

8. The computer-implemented method of claim 1, wherein prompting the first trained large language model comprises inputting a prompt according to a prompting language.

9. A computer-implemented method comprising:
prompting a first trained large language model (LLM) using a predefined prompting language to produce a plurality of responses;
filtering the plurality of responses to create a plurality of filtered responses; and
training a second LLM based on filtered responses.

10. The computer-implemented method of claim 9, wherein filtering the plurality of responses comprises inputting the plurality of responses into a third trained LLM and prompting the third trained LLM to rank the plurality of responses.

11. The computer-implemented method of claim 9, wherein the first trained LLM is the same as the second LLM.

12. The computer-implemented method of claim 10, wherein the third trained LLM is the same as the second LLM.

13. The computer-implemented method of claim 8, wherein filtering the plurality of responses to create the plurality of filtered responses comprises applying a machine learning classifier to the plurality of responses.

14. A system for training a generative artificial intelligence (AI), the system comprising:
a computing device comprising at least one processor and at least one memory, the at least one memory having computer-executable instructions stored thereon that, when executed by the at least one processor, cause the at least one processor to:
receive a prompt file;
generate a pair of responses using a trained generative AI model and the prompt file;
output a comparison of the pair of responses based on the prompt file;
train the trained generative AI model using the comparison and the pair of responses; and
store the trained generative AI model.

15. The system of claim 14, wherein the pair of responses comprise a pair of arguments.

16. The system of claim 14, wherein the trained generative AI model is a language model.

17. The system of claim 14, wherein the trained generative AI model is a large language model.

18. A computer-implemented method for providing artificial intelligence (AI)-based responses comprising:
receiving a first input file;
inputting the first input file to an iteratively trained generative AI model; and
outputting, using the iteratively trained generative AI model, a response.

19. The computer-implemented method of claim 18, wherein the iteratively trained generative AI model comprises a language model.

20. The computer-implemented method of claim 18, wherein the iteratively trained generative AI model comprises a large language model.
